(19) United States
(12) Patent Application Publication
(10) Pub. No.: US 2017/0289609 A1
(43) Pub. Date: Oct. 5, 2017

(54) METHOD AND DEVICE FOR PLAYING MULTIMEDIA DATA SYNCHRONOUSLY

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Renhua Liu, Tianjin (CN)

(21) Appl. No.: 15/247,770

(22) Filed: Aug. 25, 2016

Related U.S. Application Data
(63) Continuation of application No. PCT/CN2016/088984, filed on Jul. 6, 2016.

(30) Foreign Application Priority Data
Mar. 31, 2016 (CN) 201610201676.6

(51) Int. Cl. H04N 21/43; H04N 21/439; H04N 21/4363; H04N 21/8547

(52) U.S. Cl. CPC H04N 21/4302; H04N 21/8547; H04N 21/4394; H04N 21/43637

(57) ABSTRACT

Embodiments of the disclosure provide a method and device for playing multimedia data synchronously. The method for playing multimedia data synchronously includes: synchronizing a clock of each multimedia playing device according to a data transmission delay of time of the multimedia playing device; receiving multimedia data including a timestamp; and calculating a playback instance of time of each frame of the multimedia data according to an instance of time of the synchronized clock, a target data transmission delay of time, a period of time for which each frame of the multimedia data is buffered in the multimedia playing device, and a play instance of time of each frame of the multimedia data indicated by the timestamp, and transmitting the multimedia data and the playback instance of time of each frame of the multimedia data to the plurality of multimedia playing devices.

### CROSS-REFERENCE TO RELATED APPLICATIONS

This application is a continuation of International Application No. PCT/CN2016/088984, filed on Jul. 6, 2016, which is based upon and claims priority to Chinese Patent Application No. 201610201676.6, filed on Mar. 31, 2016, the entire contents of which are incorporated herein by reference.

### TECHNICAL FIELD

The present disclosure relates to the field of video technologies, and particularly to a method and device for playing multimedia data synchronously.

### BACKGROUND

A home cinema can be deployed based upon Wireless-Fidelity (WIFI) at a low cost without wiring into a wall, and WIFI sound boxes can be shared by a television, a mobile phone, a computer, and other home appliances, so the WIFI based home cinema is more likely to be accepted by people at home.

In the WIFI based home cinema solution, a plurality of WIFI sound boxes are connected with the television or the computer through a router, and audio data between the television and the WIFI sound boxes need to be transmitted over a network, so that the audio data of the respective sound boxes may be not synchronized with video data of the television or the computer, and even the audio data may not be synchronized between the respective WIFI sound boxes.

The inventors have identified during making of the disclosure such a problem in the prior art that the audio data may not be synchronized with the video data, and the audio data may not be synchronized with each other if the WIFI sound boxes are connected with the television or the computer for use.

### SUMMARY

Embodiments of the disclosure provide a method and device for playing multimedia data synchronously so as to address such a problem in the prior art that the audio data may not be synchronized with the video data, and the audio data may not be synchronized.

In a first aspect, embodiments of the disclosure provides a method for playing multimedia data synchronously, applicable to an electronic device, the method including: synchronizing a clock of each multimedia playing device according to a data transmission delay of time of the multimedia playing device; receiving multimedia data including a timestamp indicating a play instance of time of each frame of the multimedia data; and calculating a playback instance of time of each frame of the multimedia data according to an instance of time of the synchronized clock, a target data transmission delay of time, a period of time for which each frame of the multimedia data is buffered in the multimedia playing device, and the play instance of time of each frame of the multimedia data indicated by the timestamp, and transmitting the multimedia data and the playback instance of time of each frame of the multimedia data to a plurality of multimedia playing devices to instruct the plurality of multimedia playing devices each to play back the multimedia data according to a relationship between the received playback instance of time of each frame of the multimedia data and a current instance of time of a clock thereof, where the target data transmission delay of time is determined among the data transmission delays of time of the plurality of multimedia playing devices under a preset rule.

In a second aspect, embodiments of the disclosure provides an electronic device including: at least one processor; and a memory communicably connected with the at least one processor for storing instructions executable by the at least one processor, wherein execution of the instructions by the at least one processor causes the at least one processor to: synchronize a clock of each multimedia playing device according to a data transmission delay of time of the multimedia playing device; receive multimedia data including a timestamp indicating a play instance of time of each frame of the multimedia data; and calculate a playback instance of time of each frame of the multimedia data according to an instance of time of the synchronized clock, a target data transmission delay of time, a period of time for which each frame of the multimedia data is buffered in the multimedia playing device, and the play instance of time of each frame of the multimedia data indicated by the timestamp, and transmit the multimedia data and the playback instance of time of each frame of the multimedia data to a plurality of multimedia playing devices to instruct the plurality of multimedia playing devices each to play back the multimedia data according to a relationship between the received playback instance of time of each frame of the multimedia data and a current instance of time of a clock thereof, wherein the target data transmission delay of time is determined among the data transmission delays of time of the plurality of multimedia playing devices under a preset rule.

In a third aspect, embodiments of the disclosure provides a non-transitory computer-readable storage medium storing executable instructions that, when executed by an electronic device with a touch-sensitive display, cause the electronic device to: synchronize a clock of each multimedia playing device according to a data transmission delay of time of the multimedia playing device; receive multimedia data including a timestamp indicating a play instance of time of each frame of the multimedia data; and calculate a playback instance of time of each frame of the multimedia data according to an instance of time of the synchronized clock, a target data transmission delay of time, a period of time for which each frame of the multimedia data is buffered in the multimedia playing device, and the play instance of time of each frame of the multimedia data indicated by the timestamp, and transmit the multimedia data and the playback instance of time of each frame of the multimedia data to a plurality of multimedia playing devices to instruct the plurality of multimedia playing devices each to play back the multimedia data according to a relationship between the received playback instance of time of each frame of the multimedia data and a current instance of time of a clock thereof, wherein the target data transmission delay of time is determined among the data transmission delays of time of the plurality of multimedia playing devices under a preset rule.

In the method and device for playing multimedia data synchronously according to the embodiments of the disclosure, firstly the clock of each multimedia playing device is synchronized according to the data transmission delay of time of the multimedia playing device, where the clock is synchronized taking into account the data transmission delay of time to thereby synchronize precisely the clocks among the plurality of multimedia playing devices; and then the playback instance of time of each frame of the multimedia data is calculated according to the instance of time of the synchronized clock, the target data transmission delay of time, the period of time for which each frame of the multimedia data is buffered in the multimedia playing device, and the play instance of time of each frame of the multimedia data indicated by the timestamp, and the multimedia data and the playback instance of time of each frame of the multimedia data are transmitted to the plurality of multimedia playing devices to instruct the plurality of multimedia playing devices each to play back the multimedia data according to the relationship between the received playback instance of time of each frame of the multimedia data and the current instance of time of the clock thereof. Since the clocks are synchronized precisely among the plurality of multimedia playing device, and the playback instance of time of each frame of the multimedia data is the same, the plurality of multimedia playing devices can play the same frame of multimedia data at the same time to thereby play the multimedia data synchronously among the plurality of multimedia playing device; and as compared with the prior art in which the audio data are not synchronized with the video data, and the audio data are not synchronized with each other, the clocks are synchronized precisely among the plurality of multimedia playing devices, and further the playback instance of time of each frame of the multimedia data is calculated and transmitted to the plurality of multimedia playing devices for playing to thereby play the multimedia data synchronously among the plurality of multimedia playing devices so as to improve the experience of a user.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flow chart of a method for playing multimedia data synchronously in accordance with some embodiments.

FIG. 2 is a schematic flow chart of a particular flow of a method for playing multimedia data synchronously in accordance with some embodiments;

FIG. 3 is a schematic structural diagram of an apparatus for playing multimedia data synchronously in accordance with some embodiments;

FIG. 4 is a schematic structural diagram of another apparatus for playing multimedia data synchronously in accordance with some embodiments;

FIG. 5 is a schematic structural diagram of a further apparatus for playing multimedia data synchronously in accordance with some embodiments;

FIG. 6 is a schematic diagram of a computer readable storage medium in accordance with some embodiments; and

FIG. 7 is a schematic diagram of an electronic device for playing multimedia data synchronously in accordance with some embodiments.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

It shall be noted that a method for playing multimedia data synchronously according to an embodiment of the disclosure can be performed by an apparatus for playing multimedia data synchronously, which is connected with a plurality of multimedia paying devices, e.g., a mobile device (e.g., a handset, a wearable smart device, etc.) and a computer connected with a plurality of multimedia playing devices, or can be performed by any one multimedia playing device. For example, a plurality of multimedia paying devices include one video playing device and a plurality of audio playing devices, and if the method is performed by the video playing device, then the video playing device may transmit audio data, and playback instances of time of respective frames of the audio data to the plurality of audio playing devices for synchronous playing. Of course, the method can alternatively be performed by any one of the audio playing devices, and if the method is performed by any one of the audio playing devices, then the audio playing device may transmit audio data, and playback instances of time of the respective frames of the audio data to the audio playing devices other than the audio playing device itself, and transmit video data, and playback instances of time of respective frames of the video data to the video playing device for synchronous displaying.

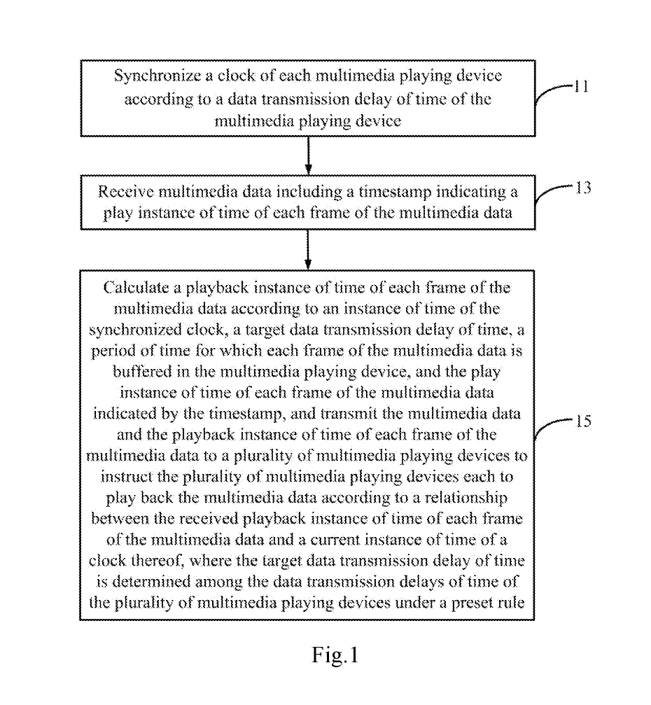

As illustrated in FIG. 1, a method for playing multimedia data synchronously according to an embodiment of the disclosure includes the following operations:

The operation 11 is to synchronize a clock of each multimedia playing device according to a data transmission delay of time of the multimedia playing device;

The operation 13 is to receive multimedia data including a timestamp indicating a play instance of time of each frame of the multimedia data; and

The operation 15 is to calculate a playback instance of time of each frame of the multimedia data according to an instance of time of the synchronized clock, a target data transmission delay of time, a period of time for which each frame of the multimedia data is buffered in the multimedia playing device, and the play instance of time of each frame of the multimedia data indicated by the timestamp, and to transmit the multimedia data and the playback instance of time of each frame of the multimedia data to the plurality of multimedia playing devices to instruct the plurality of multimedia playing devices each to play back the multimedia data according to a relationship between the received playback instance of time of each frame of the multimedia data and a current instance of time of a clock thereof, where the target data transmission delay of time is determined among the data transmission delays of time of the plurality of multimedia playing devices under a preset rule.

In the method according to the embodiment of the disclosure, firstly the clock of each multimedia playing device is synchronized according to the data transmission delay of time of the multimedia playing device, where the clock is synchronized taking into account the data transmission delay of time so that the clocks of the plurality of multimedia playing devices are synchronized precisely; and then the playback instance of time of each frame of the multimedia data is calculated according to the instance of time of the synchronized clock, the target data transmission delay of time, the period of time for which each frame of the multimedia data is buffered in the multimedia playing device and the play instance of time of each frame of the multimedia data indicated by the timestamp; and the multimedia data and the playback instance of time of each frame of the multimedia data are transmitted to the plurality of multimedia playing devices to instruct the plurality of multimedia playing devices each to play back the multimedia data according to the relationship between the received playback instance of time of each frame of the multimedia data and the current instance of time of the clock thereof. Since the clocks are synchronized precisely among the plurality of multimedia playing devices, and the playback instance of time of each frame of the multimedia data is the same, the plurality of multimedia playing devices can play the same frame of multimedia data at the same time so that the plurality of multimedia playing devices can play the multimedia data synchronously; and as compared with the prior art in which the audio data are not synchronized with the video data, and the audio data are not synchronized with each other, the clocks are synchronized precisely among the plurality of multimedia playing devices, and further the playback instance of time of each frame of the multimedia data is calculated and transmitted to the plurality of multimedia playing devices for playing to thereby play the multimedia data synchronously among the plurality of multimedia playing devices so as to improve the experience of a user.

In a particular implementation, the multimedia playing devices include at least one audio playing device and at least one video playing device, and the multimedia data include audio data and video data; and the multimedia data, and the playback instance of time of each frame of the multimedia data are transmitted to the plurality of multimedia playing devices by transmitting the audio data, and the playback instance of time of each frame of the audio data to the at least one audio playing device, and transmitting the video data, and the playback instance of time of each frame of the video data to the at least one video playing device, where the video playing device can be a television, a computer, a handset, etc., the audio playing device can be a WIFI sound box, and the timestamp indicates the play instance of time, e.g., 3:00:00 at which the multimedia data are played.

It shall be noted that in the embodiment of the disclosure, the multimedia playing devices include the audio playing device and the video playing device, and the multimedia data include the audio data and the video data, and are played by transmitting the audio data to the audio playing device for playing and transmitting the video data to the video playing device for displaying; and each frame of the multimedia data carries the timestamp indicating the play instance of time, where after the multimedia data are separated into the audio data and the video data, each frame of audio data and each frame of video data carry the timestamps, and the audio data and the video data into which the same frame of multimedia data is separated carry the same timestamps so that the playback instances of time of the audio data and the video data into which the same frame of multimedia data is separated are the same to thereby ensure the audio data and the video data to be played synchronously.

In a particular implementation, since the data transmission delay of time of each multimedia playing device may be different from each other, in order to ensure synchronous playing by the plurality of multimedia playing devices, the playback instance of time of each frame of the multimedia data may be calculated not from the data transmission delay of time of each multimedia playing device, but instead from the target data transmission delay of time which shall be determined among the data transmission delays of time of the plurality of multimedia playing devices under the preset rule, and then the playback instance of time of each frame of the multimedia data may be calculated from the target data transmission delay of time, where the preset rule can be to determine the largest one of the data transmission delays of time as the target data transmission delay of time, or to calculate the target data transmission delay of time according to the plurality of data transmission delays of time. Of course, preferably the preset rule is to determine the largest one of the data transmission delays of time as the target data transmission delay of time. If the preset rule is to determine the largest one of the data transmission delays of time as the target data transmission delay of time, then the playback instance of time of each frame of the multimedia data may be calculated according to the largest data transmission delay of time, so even the multimedia playing device corresponding to the largest data transmission delay of time can play synchronously with the other multimedia playing devices to thereby ensure the audio data and the video data to be played synchronously among the plurality of multimedia playing devices.

In a particular embodiment, in an example of a home cinema where a plurality of WIFI sound boxes are WIFI-connected with a television configured to control video data to be synchronized with audio data and to control the audio data to be synchronized among the WIFI sound boxes, there are such a plurality of WIFI sound boxes that a data transmission delay of time between each WIFI sound box and the television may be different from each other, so that in order to ensure the audio data to be played synchronously among the WIFI sound boxes, the television shall calculate a playback instance of time of each frame of audio data from a data transmission delay of time which is the largest one of the data transmission delays of time between the television and the plurality of WIFI sound boxes, that is, the target data transmission delay of time is the largest one of the data transmission delays of time between the television and the plurWIFI sound boxes.

In a particular implementation, the clock of each multimedia playing device is synchronized according to the data transmission delay of time of the multimedia playing device by transmitting for each multimedia playing device a reference instance of time, and the data transmission delay of time of the multimedia playing device to the multimedia playing device to instruct the multimedia playing device to determine the sum of the reference instance of time and the data transmission delay of time as a reference instance of time of the clock in the multimedia playing device.

In a particular implementation, since the multimedia playing devices are connected through a network or a router, there will be some delay of time in transmission of the data, and in order to ensure the clock to be synchronized precisely, the delay of time in transmission of the data should be added to the synchronized clock, so that firstly a data transmission delay of time at a next instance of time may be calculated, that is, the data transmission delay of time at the next instance of time may be estimated according to data transmission delays of time at preceding instances of time to the current instance of time so that the clocks are synchronized with the plurality of multimedia playing devices according to the data transmission delay of time at the next instance of time, where the data transmission delay of time at the next instance of time can be estimated according to the data transmission delays of time at the preceding instances of time to the current instance of time as in the prior art, e.g., in a moving window weighted algorithm particularly as follows:

In a particular embodiment, a network delay at a next instance of time is estimated using the moving window weighted algorithm, and particularly if the size of a window is N, N preceding data transmission delays of time are t_{1-N}, t_{2-N}, . . . , t₋₁, and t₀, and weights corresponding to the respective data transmission delays of time are w_{1-N}, w_{2-N}, . . . , w₋₁, and w₀, then the data transmission delay of time at the next instance of time may be calculated in the equation of:

$${t}_{1} = {\sum }_{i = 1}^{N} {w}_{i - N} \times {t}_{i - N} , where {\sum }_{i = 1}^{N} {w}_{i - N} = 1.$$

After the data transmission delay of time at the next instance of time is calculated, in an example where clocks are synchronized between a device A and a device B, the device A transmits a reference instance of time, e.g., 3:00:00, and a data transmission delay of time at a next instance of time, e.g., 1 s, to the device B, and the device B receives the reference instance of time and the data transmission delay of time, transmitted by the device A, and synchronizes the clock with the device A; the device A transmits data at the reference instance of time 3:00:00, and when the device B receives clock synchronization data transmitted by the device A, the time of the device A has been changed to 3:00:01 due to the data transmission delay of time, so the device B synchronizes the clock by determining the sum of 3:00:00 and 1 s, i.e., 3:00:01, as a reference instance of time to thereby synchronize the clock with the device A.

After the clock of each multimedia playing device is synchronized according to the data transmission delay of time of the multimedia playing device, the method further includes synchronizing periodically the clock of each multimedia playing device according to the data transmission delay of time of the multimedia playing device.

In a particular implementation, the clock of each multimedia playing device is synchronized periodically according to the data transmission delay of time of the multimedia playing device so that the clocks can be synchronized precisely among the plurality of multimedia playing devices, and in order to improve the precision, the periodicity at which the clock is synchronized can be shortened, for example, the clock is synchronized at a periodicity of 10 minutes; and on the other hand, in order to lower an overhead of clock synchronization, the periodicity at which the clock is synchronized can be lengthened, for example, the clock is synchronized at a periodicity of 60 minutes.

In a possible implementation, the playback instance of time of each frame of the multimedia data is calculated according to the instance of time of the synchronized clock, the target data transmission delay of time, the period of time for which each frame of the multimedia data is buffered in the multimedia playing device, and the play instance of time of each frame of the multimedia data indicated by the timestamp, by determining for the first frame of multimedia data the playback instance of time of the frame of multimedia data to be the sum of the instance of time of the synchronized clock, the target data transmission delay of time, and the period of time for which each frame of the multimedia data is buffered in the multimedia playing device; and determining, for each frame of the multimedia data succeeding to the first frame of multimedia data, the playback instance of time of the frame of multimedia data to be the sum of the difference between the play instance of time of the frame of multimedia data and the play instance of time of the first frame of multimedia data, the instance of time of the synchronized clock, the target data transmission delay of time, and the period of time for which each frame of the multimedia data is buffered in the multimedia playing device.

In a particular implementation, in an example where there are audio data and video data, the playback instance of time Tₐₚ of each frame of audio data is calculated according to the play instance of time Tₐₚₜₛ (i.e., the play instance of time indicated by the timestamp) of each frame of audio data, the data transmission delay of time T₁, the system instance of time Tₛ (i.e., the instance of time of the synchronized clock), and the period of time T_{b} for which each frame of audio data is buffered, in the equation of:

For the first frame of audio data: Tₐₚ=T_{b}+T₁+Tₛ; and

For the other frames of audio data succeeding to the first frame of audio data:

Tₐₚ=T_{b}+Tₐₚₜₛ−T_{apts′}+T₁+Tₛ;

Where Tₐₚₜₛ represents the play instance of time of the current frame of audio data, and T_{apts′} represents the play instance of time of the first frame of audio data, in milliseconds.

The playback instance of time Tᵥₚ of each frame of video data is calculated according to the play instance of time Tᵥₚₜₛ (i.e., the play instance of time indicated by the timestamp) of each frame of video data, the data transmission delay of time T₁, the system instance of time Tₛ, and the period of time T_{b} for which each frame of video data is buffered, in the equation of:

For the first frame of video data: Tᵥₚ=T_{b}+T₁+Tₛ; and

For the other frames of video data succeeding to the first frame of video data:

Tᵥₚ=T_{b}+Tᵥₚₜₛ−T_{vpts′}+T₁+Tₛ;

Where the period of time for which each frame of video data is buffered is the same as the period of time for which each frame of audio data is buffered, Tᵥₚₜₛ represents the play instance of time of the current frame of video data, and T_{vpts′} represents the play instance of time of the first frame of video data, in milliseconds.

In a possible implementation, in the method according to the embodiment of the disclosure, the plurality of multimedia playing devices each are instructed to play back the multimedia data according to the relationship between the received playback instance of time of each frame of the multimedia data and the current instance of time of a clock thereof by: instructing for each frame of the multimedia data the plurality of multimedia playing devices each to play back the frame of multimedia data upon determining that the playback instance of time of the frame of multimedia data is greater than or equal to the current instance of time of the clock thereof, and the difference between the playback instance of time of the frame of multimedia data and the current instance of time of the clock thereof is less than or equal to a preset threshold; instructing the plurality of multimedia playing devices each to buffer the frame of multimedia data upon determining that the difference between the playback instance of time of the frame of multimedia data and the current instance of time of the clock thereof is greater than the preset threshold; and instructing the plurality of multimedia playing devices each to discard the frame of multimedia data upon determining that the playback instance of time of the frame of multimedia data is less than the current instance of time of the clock thereof.

In a particular implementation, in an example where audio data and video data are played back, the audio playing device determines whether to play back each frame of audio data, according to the playback instance of time of each frame of audio data and the time of the clock in the audio playing device under the following criterion:

If Tₐₚ≧Tₛ, and Tₐₚ≦Tₛ+Td_{iff}, then this will indicate that the playback instance of time of the frame of audio data satisfies the condition to play back the audio data, and the frame of audio data will be played back;

If Tₐₚ>Tₛ+Td_{iff}, then this will indicate that the frame of audio data has been transmitted, but the playback instance of time of the frame of audio data has not arrived, so the frame of audio data will be put into a buffer area, and wait for being played back; and

If Tₐₚ<Tₛ, that is, the system time is greater than the playback instance of time of the frame of audio data, then the frame of audio data will not be played back, and thus discarded.

Here the preset threshold T_{diff} can be preset empirically, and generally T_{diff} takes the largest error of no greater than 50 ms, for example, the value of the preset threshold T_{diff} is 30 ms.

The video data are played back under a similar criterion to the criterion under which the audio data are played back, and particularly the video playing device determines whether to play back each frame of video data, according to the playback instance of time of each frame of video data and the time of the clock in the video playing device under the following criterion:

If Tᵥₚ≧Tₛ, and Tᵥₚ≦Tₛ+Td_{iff}, then this will indicate that the playback instance of time of the frame of video data satisfies the condition to play back the video data, and the frame of video data will be played back;

If Tᵥₚ>Tₛ+Td_{iff}, then this will indicate that the frame of video data has been transmitted, but the playback instance of time of the frame of video data has not arrived, so the frame of video data will be put into a buffer area, and wait for being played back; and

If Tᵥₚ<Tₛ, that is, the system time is greater than the playback instance of time of the frame of video data, then the frame of video data will not be played back, and thus discarded.

Here the preset threshold T_{diff} can be preset empirically, and generally T_{diff} takes the largest error of no greater than 50 ms, for example, the value of the preset threshold T_{diff} is 30 ms.

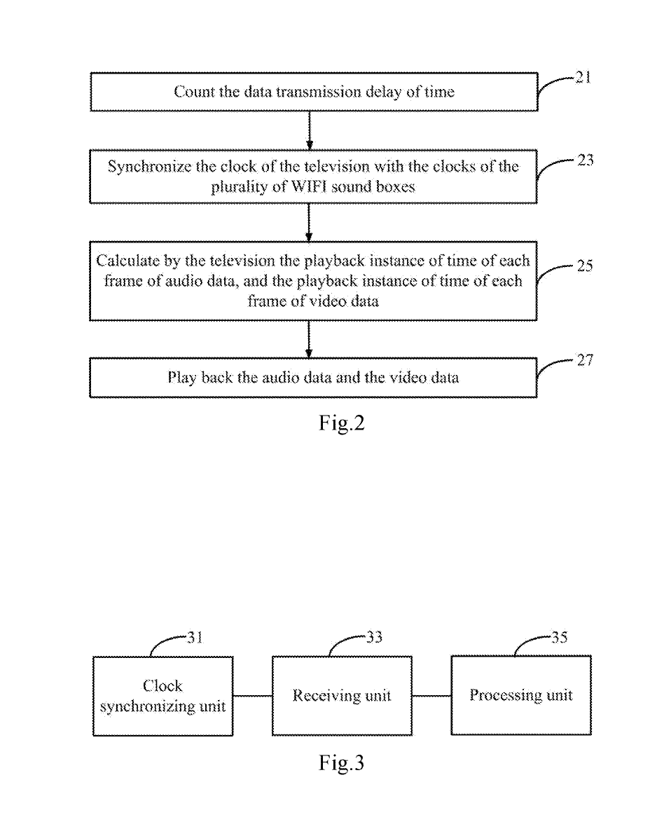

The method for playing multimedia data synchronously according to an embodiment of the disclosure as illustrated in FIG. 2 will be described below in details by way of an example of a home cinema where a plurality of WIFI sound boxes are WIFI-connected with a television configured to control video data to be synchronized with audio data and to control the audio data to be synchronized among the plurality of WIFI sound boxes, where the method for playing multimedia data synchronously according to an embodiment of the disclosure as illustrated in FIG. 2 includes the following particular operations

The operation 21 is to count the data transmission delay of time, where particularly the television counts the data transmission delay of time between the television and each WIFI sound box, and estimates the data transmission delay of time between the television and each WIFI sound box at the next instance of time;

The operation 23 is to synchronize the clock of the television with the clocks of the plurality of WIFI sound boxes, where particularly for each WIFI sound box, the television transmits the reference instance of time for clock synchronization, and the data transmission delay of time between the television and the WIFI sound box at the next instance of time to the WIFI sound box, and the WIFI sound box determines the sum of the reference instance of time and the data transmission delay of time as the reference instance of time of the clock thereof upon reception of the reference instance of time and the data transmission delay of time;

The operation 25 is to calculate by the television the playback instance of time of each frame of audio data, and the playback instance of time of each frame of video data, where particularly the television calculates the playback instance of time of each frame of audio data according to the instance of time of the synchronized clock, the target data transmission delay of time, the period of time for which each frame of audio data is buffered in the WIFI sound box and the play instance of time of each frame of audio data, and transmits the audio data and the playback instance of time of each frame of audio data to the plurality of WIFI sound boxes; and since the data transmission delays of time of the plurality of WIFI sound boxes and the television may be different from each other, in order to ensure synchronous playing by the plurality of WIFI sound boxes, the playback instance of time of each frame of audio data is calculated using the target data transmission delay of time which is the largest one of the data transmission delays of time between the television and the plurality of WIFI sound boxes. The television calculates the playback instance of time of each frame of video data according to the instance of time of the synchronized clock, the target data transmission delay of time, the period of time for which each frame of video data is buffered in the television and the play instance of time of each frame of video data, and since the television is the video playing device, in order to synchronize the video data to be played synchronously with the audio data, the playback instance of time of each frame of video data is still calculated using the target data transmission delay of time which is the largest one of the data transmission delays of time between the television and the plurality of WIFI sound boxes; and

The operation 27 is to play back the audio data and the video data, where particularly the television plays back each frame of video data according to the relationship between the playback instance of time of each frame of video data and the current instance of time of the clock thereof, and the plurality of WIFI sound boxes each play back each frame of audio data according to the relationship between the playback instance of time of each frame of audio data and the current instance of time of the clock thereof.

In this embodiment, in order to improve the effect of clock synchronization, the clock of the television is synchronized with the clocks of the WIFI sound boxes by taking into account in real time the data transmission delay of time, and recalculating the playback instance of time of each frame of audio data, and the playback instance of time of each frame of video data to thereby ensure the audio and video data to be synchronized between the television and the WIFI sound boxes so as to improve the experience of the user, and to facilitate popularization and applications of the wireless WIFI home cinema, and popularization of WIFI smart sound boxes, thus enabling the WIFI sound boxes to become shared sound boxes of a television, a handset, a computer, and other home appliances.

An embodiment of the disclosure provides an apparatus for playing multimedia data synchronously as illustrated in FIG. 3, where the apparatus includes: a clock synchronizing unit 31 configured to synchronize a clock of each multimedia playing device according to a data transmission delay of time of the multimedia playing device; a receiving unit 33 configured to receive multimedia data including a timestamp indicating a play instance of time of each frame of the multimedia data; and a processing unit 35 configured to calculate a playback instance of time of each frame of the multimedia data according to an instance of time of the synchronized clock, a target data transmission delay of time, a period of time for which each frame of the multimedia data is buffered in the multimedia playing device, and the play instance of time of each frame of the multimedia data indicated by the timestamp, and to transmit the multimedia data and the playback instance of time of each frame of the multimedia data to a plurality of multimedia playing devices to instruct the plurality of multimedia playing devices each to play back the multimedia data according to a relationship between the received playback instance of time of each frame of the multimedia data and a current instance of time of a clock thereof, where the target data transmission delay of time is determined among the data transmission delays of time of the plurality of multimedia playing devices under a preset rule.

In the apparatus according to the embodiment of the disclosure, firstly the clock of each multimedia playing device is synchronized according to the data transmission delay of time of the multimedia playing device, where the clock is synchronized taking into account the data transmission delay of time to thereby synchronize precisely the clocks among the plurality of multimedia playing devices; and then the playback instance of time of each frame of the multimedia data is calculated according to the instance of time of the synchronized clock, the target data transmission delay of time, the period of time for which each frame of the multimedia data is buffered in the multimedia playing device and the play instance of time of each frame of the multimedia data indicated by the timestamp; and the multimedia data and the playback instance of time of each frame of the multimedia data are transmitted to the plurality of multimedia playing devices to instruct the plurality of multimedia playing devices each to play back the multimedia data according to the relationship between the received playback instance of time of each frame of the multimedia data and the current instance of time of the clock thereof. Since the clocks are synchronized precisely among the plurality of multimedia playing device, and the playback instance of time of each frame of the multimedia data is the same, the plurality of multimedia playing devices can play the same frame of multimedia data at the same time so that the plurality of multimedia playing devices can play the multimedia data synchronously; and as compared with the prior art in which the audio data are not synchronized with the video data, and the audio data are not synchronized with each other, the clocks are synchronized precisely among the plurality of multimedia playing devices, and further the playback instance of time of each frame of the multimedia data is calculated and transmitted to the plurality of multimedia playing devices for playing to thereby play the multimedia data synchronously among the plurality of multimedia playing devices so as to improve the experience of a user.

In a particular implementation, in the apparatus according to the embodiment of the disclosure, the clock synchronizing unit 31 is configured to transmit for each multimedia playing device a reference instance of time, and the data transmission delay of time of the multimedia playing device to the multimedia playing device to instruct the multimedia playing device to determine the sum of the reference instance of time and the data transmission delay of time as a reference instance of time of the clock in the multimedia playing device.

In a particular implementation, in the apparatus according to the embodiment of the disclosure, the processing unit 35 configured to calculate the playback instance of time of each frame of the multimedia data according to the instance of time of the synchronized clock, the target data transmission delay of time, the period of time for which each frame of the multimedia data is buffered in the multimedia playing device, and the play instance of time of each frame of the multimedia data indicated by the timestamp is configured to determine for the first frame of multimedia data the playback instance of time of the frame of multimedia data to be the sum of the instance of time of the synchronized clock, the target data transmission delay of time, and the period of time for which each frame of the multimedia data is buffered in the multimedia playing device; and to determine, for each frame of the multimedia data succeeding to the first frame of multimedia data, the playback instance of time of the frame of multimedia data to be the sum of the difference between the play instance of time of the frame of multimedia data, and the play instance of time of the first frame of multimedia data, the instance of time of the synchronized clock, the target data transmission delay of time, and the period of time for which each frame of the multimedia data is buffered in the multimedia playing device.

In a particular implementation, in the apparatus according to the embodiment of the disclosure, the processing unit 35 configured to instruct the plurality of multimedia playing devices each to play back the multimedia data according to the relationship between the received playback instance of time of each frame of the multimedia data and the current instance of time of the clock thereof is configured to instruct for each frame of the multimedia data the plurality of multimedia playing devices each to play back the frame of multimedia data upon determining that the playback instance of time of the frame of multimedia data is greater than or equal to the current instance of time of the clock thereof, and the difference between the playback instance of time of the frame of multimedia data and the current instance of time of the clock thereof is less than or equal to a preset threshold; to instruct the plurality of multimedia playing devices each to buffer the frame of multimedia data upon determining that the difference between the playback instance of time of the frame of multimedia data and the current instance of time of the clock thereof is greater than the preset threshold; and to instruct the plurality of multimedia playing devices each to discard the frame of multimedia data upon determining that the playback instance of time of the frame of multimedia data is less than the current instance of time of the clock thereof.

In a particular implementation, in the apparatus according to the embodiment of the disclosure, the clock synchronizing unit 31 configured to synchronize the clock of each multimedia playing device according to the data transmission delay of time of the multimedia playing device is configured to synchronize periodically the clock of each multimedia playing device according to the data transmission delay of time of the multimedia playing device.

In a particular implementation, in the apparatus according to the embodiment of the disclosure, the multimedia playing devices include at least one audio playing device and at least one video playing device, and the multimedia data include audio data and video data; and the processing unit 35 configured to transmit the multimedia data, and the playback instance of time of each frame of the multimedia data to the plurality of multimedia playing devices is configured to transmit the audio data and the playback instance of time of each frame of audio data to the at least one audio playing device, and to transmit the video data and the playback instance of time of each frame of video data to the at least one video playing device.

An apparatus for playing multimedia data synchronously according to an embodiment of the disclosure can be integrated in a device configured to control audio and video playing, or can be integrated in an audio playing device or a video playing device, where the clock synchronizing unit 31 and the processing unit 35 can be embodied as a CPU processor, etc., and the receiving unit 33 can be embodied as a receiver, a signal receiver, etc.

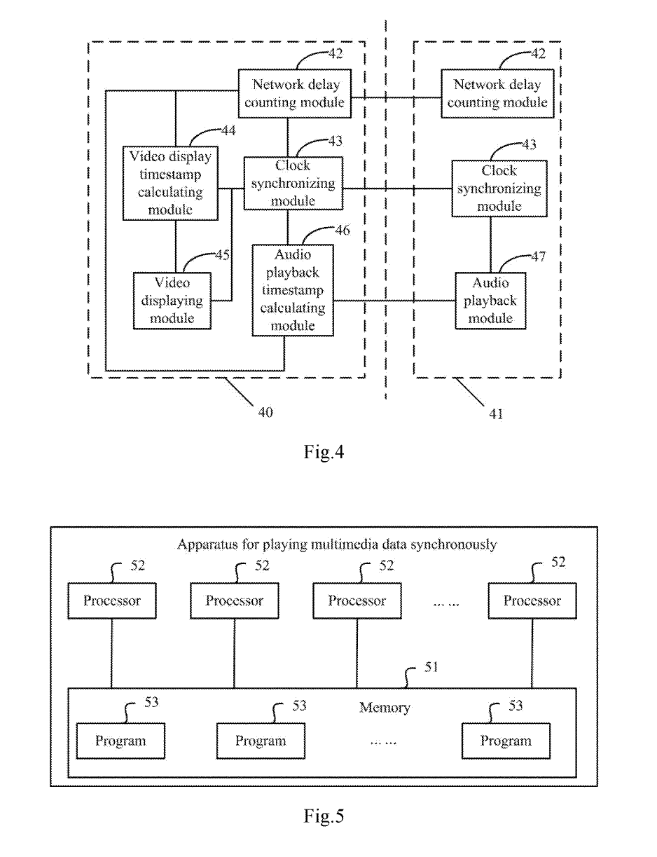

In a particular embodiment, in an example of a home cinema where a plurality of WIFI sound boxes are WIFI-connected with a television, a handset, a computer, or other home appliances, and the television is configured to control video data to be synchronized with audio data and to control the audio data to be synchronized among the plurality of WIFI sound boxes, an embodiment of the disclosure provides another apparatus for playing multimedia data synchronously as illustrated in FIG. 4, where the apparatus includes a network delay counting module 42, a clock synchronizing module 43, and an audio playback module 47 at the WIFI sound box side 41; and a network delay counting module 42, a clock synchronizing module 43, a video display timestamp calculating module 44, a video displaying module 45, and an audio playback timestamp calculating module 46 at the television, handset, computer, and other home appliance side 40, and functions of the respective modules are as follows:

The network delay counting module 42 at the home appliance side 40 is configured to count a network delay of time, to estimate a network delay of time at a next instance of time, and to transmit the network delay of time at the next instance of time to the network delay counting module 42 at the WIFI sound box side 41;

The clock synchronizing module 43 at the home appliance side 40 is configured to synchronize a clock with the clock synchronizing module 43 at the WIFI sound box side 41 according to the network delay of time at the next instance of time estimated by the network delay counting module 42;

The video display playback timestamp calculating module 44 at the home appliance side 40 is configured to calculate a playback instance of time of each frame of video data, and to transmit the video data and the playback instance of time of each frame of video data to the video displaying module for displaying;

The video displaying module 45 at the home appliance side 40 is configured to display each frame of video data according to a relationship between the playback instance of time of each frame of video data and a current instance of time of the clock thereof;

The audio playback timestamp calculating module 46 at the home appliance side 40 is configured to calculate a playback instance of time of each frame of audio data, and to transmit the audio data and the playback instance of time of each frame of audio data to the audio playback module at the WIFI sound box side 41 for playback; and

The audio playback module 47 at the WIFI sound box side 41 is configured to play back the audio data according to a relationship between the playback instance of time of each frame of audio data and a current instance of time of a clock thereof.

In this embodiment, the network delay counting module 42 and the clock synchronizing module 43 are equivalent to the clock synchronizing unit 31 in FIG. 3, and the video display timestamp calculating module 44, the video displaying module 45, the audio playback timestamp calculating module 46, and the audio playback module 47 are equivalent to the processing unit 35 in FIG. 3; and a module in the receiving unit 33 in FIG. 3 configured to receive the video data and the audio data has not been illustrated in this embodiment.

As illustrated in FIG. 5, there is a schematic structural diagram of a further apparatus for playing multimedia data synchronously according to an embodiment of the disclosure, where the apparatus includes a memory 51, one or more processors 52, and one or more programs, where the one or more programs 53 are configured, upon being executed by the one or more processors 52, to perform the operations of: synchronizing a clock of each multimedia playing device according to a data transmission delay of time of the multimedia playing device; receiving multimedia data including a timestamp indicating a play instance of time of each frame of the multimedia data; and calculating a playback instance of time of each frame of the multimedia data according to an instance of time of the synchronized clock, a target data transmission delay of time, a period of time for which each frame of the multimedia data is buffered in the multimedia playing device, and the play instance of time of each frame of the multimedia data indicated by the timestamp, and transmitting the multimedia data and the playback instance of time of each frame of the multimedia data to the a plurality of multimedia playing devices to instruct the plurality of multimedia playing devices each to play back the multimedia data according to a relationship between the received playback instance of time of each frame of the multimedia data and a current instance of time of a clock thereof, where the target data transmission delay of time is determined among the data transmission delays of time of the plurality of multimedia playing devices under a preset rule.

An embodiment of the disclosure further provides a computer readable storage medium on which there are stored computer executable instructions configured to be executed by an apparatus for playing multimedia data synchronously to perform the operations of: synchronizing a clock of each multimedia playing device according to a data transmission delay of time of the multimedia playing device; receiving multimedia data including a timestamp indicating a play instance of time of each frame of the multimedia data; and calculating a playback instance of time of each frame of the multimedia data according to an instance of time of the synchronized clock, a target data transmission delay of time, a period of time for which each frame of the multimedia data is buffered in the multimedia playing device, and the play instance of time of each frame of the multimedia data indicated by the timestamp, and transmitting the multimedia data and the playback instance of time of each frame of the multimedia data to a plurality of multimedia playing devices to instruct the plurality of multimedia playing devices each to play back the multimedia data according to a relationship between the received playback instance of time of each frame of the multimedia data and a current instance of time of a clock thereof, where the target data transmission delay of time is determined among the data transmission delays of time of the plurality of multimedia playing devices under a preset rule.

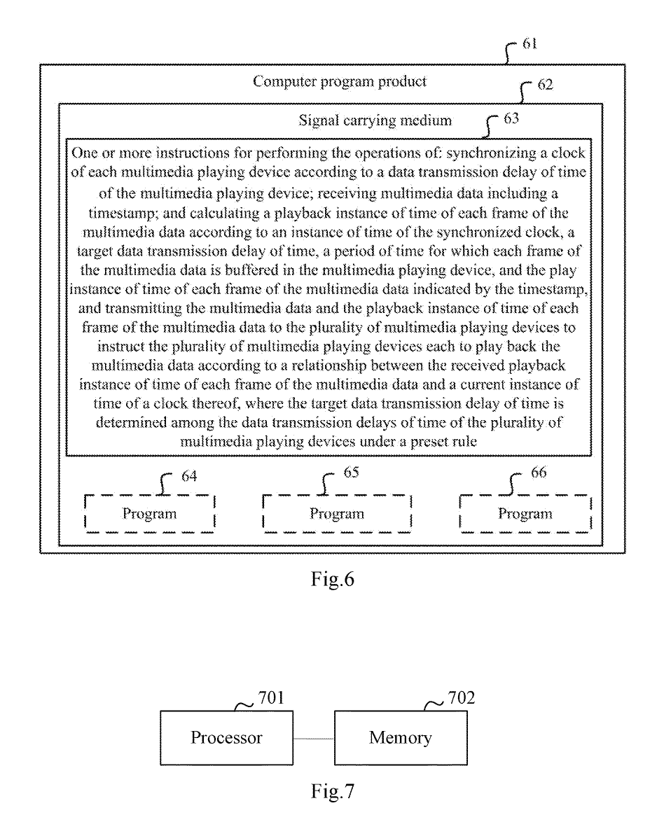

As illustrated in FIG. 6, a computer readable storage medium 61 stores thereon a computer program product 62 which can include any combination of one or more readable medium, e.g., a signal carrying medium 63, a computer readable medium 64, a recordable medium 65, a communication medium 66, etc., where the signal carrying medium 63 stores therein one or more instructions for performing the operations of: synchronizing a clock of each multimedia playing device according to a data transmission delay of time of the multimedia playing device; receiving multimedia data including a timestamp; and calculating a playback instance of time of each frame of the multimedia data according to an instance of time of the synchronized clock, a target data transmission delay of time, a period of time for which each frame of the multimedia data is buffered in the multimedia playing device, and the play instance of time of each frame of the multimedia data indicated by the timestamp, and transmitting the multimedia data and the playback instance of time of each frame of the multimedia data to a plurality of multimedia playing devices to instruct the plurality of multimedia playing devices each to play back the multimedia data according to a relationship between the received playback instance of time of each frame of the multimedia data and a current instance of time of a clock thereof, where the target data transmission delay of time is determined among the data transmission delays of time of the plurality of multimedia playing devices under a preset rule.

In the method and apparatus for playing multimedia data synchronously according to the embodiments of the disclosure, firstly the clock of each multimedia playing device is synchronized according to the data transmission delay of time of the multimedia playing device, where the clock is synchronized taking into account the data transmission delay of time to thereby synchronize precisely the clocks among the plurality of multimedia playing devices; and then the playback instance of time of each frame of the multimedia data is calculated according to the instance of time of the synchronized clock, the target data transmission delay of time, the period of time for which each frame of the multimedia data is buffered in the multimedia playing device, and the play instance of time of each frame of the multimedia data indicated by the timestamp, and the multimedia data and the playback instance of time of each frame of the multimedia data are transmitted to the plurality of multimedia playing devices to instruct the plurality of multimedia playing devices each to play back the multimedia data according to the relationship between the received playback instance of time of each frame of the multimedia data and the current instance of time of the clock thereof. Since the clocks are synchronized precisely among the plurality of multimedia playing device, and the playback instance of time of each frame of the multimedia data is the same, the plurality of multimedia playing devices can play the same frame of multimedia data at the same time to thereby play the multimedia data synchronously among the plurality of multimedia playing device; and as compared with the prior art in which the audio data are not synchronized with the video data, and the audio data are not synchronized with each other, the clocks are synchronized precisely among the plurality of multimedia playing device, and further the playback instance of time of each frame of the multimedia data is calculated and transmitted to the plurality of multimedia playing devices for playing to thereby play the multimedia data synchronously among the multimedia playing devices so as to improve the experience of a user.

Based upon the same inventive idea, an embodiment of the disclosure further provides an electronic device for playing multimedia data synchronously, as illustrated in FIG. 7, which includes:

At least one processor 701 and a memory 702, where there is one processor as an example in FIG. 7.

The memory 702 is communicably connected with the at least one processor for storing instructions executable by the at least one processor, wherein execution of the instructions by the at least one processor causes the at least one processor to:

Synchronize a clock of each multimedia playing device according to a data transmission delay of time of the multimedia playing device;

Receive multimedia data comprising a timestamp indicating a play instance of time of each frame of the multimedia data; and

Calculate a playback instance of time of each frame of the multimedia data according to an instance of time of the synchronized clock, a target data transmission delay of time, a period of time for which each frame of the multimedia data is buffered in the multimedia playing device and the play instance of time of each frame of the multimedia data indicated by the timestamp, and transmit the multimedia data and the playback instance of time of each frame of the multimedia data to a plurality of multimedia playing devices to instruct the plurality of multimedia playing devices each to play back the multimedia data according to a relationship between the received playback instance of time of each frame of the multimedia data and a current instance of time of a clock thereof, where the target data transmission delay of time is determined among the data transmission delays of time of the plurality of multimedia playing devices under a preset rule.

In one embodiment, the execution of the instructions by the at least one processor further causes the at least one processor to:

Transmit for each multimedia playing device a reference instance of time, and the data transmission delay of time of the multimedia playing device to the multimedia playing device to instruct the multimedia playing device to determine the sum of the reference instance of time and the data transmission delay of time as a reference instance of time of the clock in the multimedia playing device.

In one embodiment, the execution of the instructions by the at least one processor further causes the at least one processor to:

Determine, for the first frame of multimedia data, the playback instance of time of the frame of multimedia data to be the sum of the instance of time of the synchronized clock, the target data transmission delay of time, and the period of time for which each frame of the multimedia data is buffered in the multimedia playing device; and

Determine, for each frame of the multimedia data succeeding to the first frame of multimedia data, the playback instance of time of the frame of multimedia data to be the sum of the difference between the play instance of time of the frame of multimedia data and the play instance of time of the first frame of multimedia data, the instance of time of the synchronized clock, the target data transmission delay of time, and the period of time for which each frame of the multimedia data is buffered in the multimedia playing device.

In one embodiment, the execution of the instructions by the at least one processor further causes the at least one processor to:

For each frame of the multimedia data,

Instruct the plurality of multimedia playing devices each to play back the frame of multimedia data upon determining that the playback instance of time of the frame of multimedia data is greater than or equal to the current instance of time of the clock thereof, and the difference between the playback instance of time of the frame of multimedia data and the current instance of time of the clock thereof is less than or equal to a preset threshold;

Instruct the plurality of multimedia playing devices each to buffer the frame of multimedia data upon determining that the difference between the playback instance of time of the frame of multimedia data and the current instance of time of the clock thereof is greater than the preset threshold; and

Instruct the plurality of multimedia playing devices each to discard the frame of multimedia data upon determining that the playback instance of time of the frame of multimedia data is less than the current instance of time of the clock thereof.

In one embodiment, the execution of the instructions by the at least one processor further causes the at least one processor to:

Synchronize periodically the clock of each multimedia playing device according to the data transmission delay of time of the multimedia playing device.

In one embodiment, the multimedia playing devices include at least one audio playing device and at least one video playing device, and the multimedia data include audio data and video data; and the execution of the instructions by the at least one processor further causes the at least one processor to:

Transmit the audio data and the playback instance of time of each frame of audio data to the at least one audio playing device, and transmit the video data and the playback instance of time of each frame of video data to the at least one video playing device.

Based upon the same inventive idea, an embodiment of the disclosure further provides a non-transitory computer-readable storage medium storing executable instructions that, when executed by an electronic device with a touch-sensitive display, cause the electronic device to:

Synchronize a clock of each multimedia playing device according to a data transmission delay of time of the multimedia playing device;

Receive multimedia data comprising a timestamp indicating a play instance of time of each frame of the multimedia data; and

Calculate a playback instance of time of each frame of the multimedia data according to an instance of time of the synchronized clock, a target data transmission delay of time, a period of time for which each frame of the multimedia data is buffered in the multimedia playing device and the play instance of time of each frame of the multimedia data indicated by the timestamp, and transmit the multimedia data and the playback instance of time of each frame of the multimedia data to a plurality of multimedia playing devices to instruct the plurality of multimedia playing devices each to play back the multimedia data according to a relationship between the received playback instance of time of each frame of the multimedia data and a current instance of time of a clock thereof, where the target data transmission delay of time is determined among the data transmission delays of time of the plurality of multimedia playing devices under a preset rule.

In one embodiment, the executable instructions executed by the electronic device further cause the electronic device to:

Transmit for each multimedia playing device a reference instance of time, and the data transmission delay of time of the multimedia playing device to the multimedia playing device to instruct the multimedia playing device to determine the sum of the reference instance of time and the data transmission delay of time as a reference instance of time of the clock in the multimedia playing device.

In one embodiment, the executable instructions executed by the electronic device further cause the electronic device to:

Determine, for the first frame of multimedia data, the playback instance of time of the frame of multimedia data to be the sum of the instance of time of the synchronized clock, the target data transmission delay of time, and the period of time for which each frame of the multimedia data is buffered in the multimedia playing device; and

Determine, for each frame of the multimedia data succeeding to the first frame of multimedia data, the playback instance of time of the frame of multimedia data to be the sum of the difference between the play instance of time of the frame of multimedia data and the play instance of time of the first frame of multimedia data, the instance of time of the synchronized clock, the target data transmission delay of time, and the period of time for which each frame of the multimedia data is buffered in the multimedia playing device.

In one embodiment, the executable instructions executed by the electronic device further cause the electronic device to:

For each frame of the multimedia data,

Instruct the plurality of multimedia playing devices each to play back the frame of multimedia data upon determining that the playback instance of time of the frame of multimedia data is greater than or equal to the current instance of time of the clock thereof, and the difference between the playback instance of time of the frame of multimedia data and the current instance of time of the clock thereof is less than or equal to a preset threshold;

Instruct the plurality of multimedia playing devices each to buffer the frame of multimedia data upon determining that the difference between the playback instance of time of the frame of multimedia data and the current instance of time of the clock thereof is greater than the preset threshold; and

Instruct the plurality of multimedia playing devices each to discard the frame of multimedia data upon determining that the playback instance of time of the frame of multimedia data is less than the current instance of time of the clock thereof.

In one embodiment, the executable instructions executed by the electronic device further cause the electronic device to:

Synchronize periodically the clock of each multimedia playing device according to the data transmission delay of time of the multimedia playing device.

In one embodiment, the multimedia playing devices include at least one audio playing device and at least one video playing device, and the multimedia data include audio data and video data; and the executable instructions executed by the electronic device further cause the electronic device to:

Transmit the audio data and the playback instance of time of each frame of audio data to the at least one audio playing device, and transmit the video data and the playback instance of time of each frame of video data to the at least one video playing device.

The electronic device according to some embodiments of the disclosure can be in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those ordinarily skilled in the art can appreciate that all or a part of the operations in the methods according to the embodiments described above can be performed by program instructing relevant hardware, where the programs can be stored in a computer readable storage medium, and the programs can perform one or a combination of the operations in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for playing multimedia data synchronously, applicable to an electronic device, the method comprising:
synchronizing a clock of each multimedia playing device according to a data transmission delay of time of the multimedia playing device;
receiving multimedia data comprising a timestamp indicating a play instance of time of each frame of the multimedia data; and
calculating a playback instance of time of each frame of the multimedia data according to an instance of time of the synchronized clock, a target data transmission delay of time, a period of time for which each frame of the multimedia data is buffered in the multimedia playing device and the play instance of time of each frame of the multimedia data indicated by the timestamp, and transmitting the multimedia data and the playback instance of time of each frame of the multimedia data to a plurality of multimedia playing devices to instruct the plurality of multimedia playing devices each to play back the multimedia data according to a relationship between the received playback instance of time of each frame of the multimedia data and a current instance of time of a clock thereof, where the target data transmission delay of time is determined among the data transmission delays of time of the plurality of multimedia playing devices under a preset rule.

2. The method according to claim 1, wherein the synchronizing the clock of each multimedia playing device according to the data transmission delay of time of the multimedia playing device comprises:
transmitting for each multimedia playing device a reference instance of time, and the data transmission delay of time of the multimedia playing device to the multimedia playing device to instruct the multimedia playing device to determine the sum of the reference instance of time and the data transmission delay of time as a reference instance of time of the clock in the multimedia playing device.

3. The method according to claim 1, wherein the calculating the playback instance of time of each frame of the multimedia data according to the instance of time of the synchronized clock, the target data transmission delay of time, the period of time for which each frame of the multimedia data is buffered in the multimedia playing device, and the play instance of time of each frame of the multimedia data indicated by the timestamp comprises:
determining, for the first frame of multimedia data, the playback instance of time of the frame of multimedia data to be the sum of the instance of time of the synchronized clock, the target data transmission delay of time, and the period of time for which each frame of the multimedia data is buffered in the multimedia playing device; and
determining, for each frame of the multimedia data succeeding to the first frame of multimedia data, the playback instance of time of the frame of multimedia data to be the sum of the difference between the play instance of time of the frame of multimedia data and the play instance of time of the first frame of multimedia data, the instance of time of the synchronized clock, the target data transmission delay of time, and the period of time for which each frame of the multimedia data is buffered in the multimedia playing device.

4. The method according to claim 1, wherein the instructing the plurality of multimedia playing devices each to play back the multimedia data according to the relationship between the received playback instance of time of each frame of the multimedia data and the current instance of time of the clock thereof comprises: for each frame of the multimedia data, instructing the plurality of multimedia playing devices each to play back the frame of multimedia data upon determining that the playback instance of time of the frame of multimedia data is greater than or equal to the current instance of time of the clock thereof, and the difference between the playback instance of time of the frame of multimedia data and the current instance of time of the clock thereof is less than or equal to a preset threshold;
instructing the plurality of multimedia playing devices each to buffer the frame of multimedia data upon determining that the difference between the playback instance of time of the frame of multimedia data and the current instance of time of the clock thereof is greater than the preset threshold; and
instructing the plurality of multimedia playing devices each to discard the frame of multimedia data upon determining that the playback instance of time of the frame of multimedia data is less than the current instance of time of the clock thereof.

5. The method according to claim 1, wherein after synchronizing the clock of each multimedia playing device according to the data transmission delay of time of the multimedia playing device, the method further comprises:
synchronizing periodically the clock of each multimedia playing device according to the data transmission delay of time of the multimedia playing device.

6. The method according to claim 1, wherein the multimedia playing devices comprise at least one audio playing device and at least one video playing device, and the multimedia data comprise audio data and video data; and
the transmitting the multimedia data and the playback instance of time of each frame of the multimedia data to the plurality of multimedia playing devices comprises:
transmitting the audio data and the playback instance of time of each frame of audio data to the at least one audio playing device, and transmitting the video data and the playback instance of time of each frame of video data to the at least one video playing device.

7. An electronic device, comprising:
at least one processor; and
a memory communicably connected with the at least one processor for storing instructions executable by the at least one processor, wherein execution of the instructions by the at least one processor causes the at least one processor to:
synchronize a clock of each multimedia playing device according to a data transmission delay of time of the multimedia playing device;
receive multimedia data comprising a timestamp indicating a play instance of time of each frame of the multimedia data; and
calculate a playback instance of time of each frame of the multimedia data according to an instance of time of the synchronized clock, a target data transmission delay of time, a period of time for which each frame of the multimedia data is buffered in the multimedia playing device and the play instance of time of each frame of the multimedia data indicated by the timestamp, and transmit the multimedia data and the playback instance of time of each frame of the multimedia data to a plurality of multimedia playing devices to instruct the plurality of multimedia playing devices each to play back the multimedia data according to a relationship between the received playback instance of time of each frame of the multimedia data and a current instance of time of a clock thereof, where the target data transmission delay of time is determined among the data transmission delays of time of the plurality of multimedia playing devices under a preset rule.

8. The electronic device according to claim 7, wherein the execution of the instructions by the at least one processor further causes the at least one processor to:
transmit for each multimedia playing device a reference instance of time, and the data transmission delay of time of the multimedia playing device to the multimedia playing device to instruct the multimedia playing device to determine the sum of the reference instance of time and the data transmission delay of time as a reference instance of time of the clock in the multimedia playing device.

9. The electronic device according to claim 7, wherein the execution of the instructions by the at least one processor further causes the at least one processor to:
determine, for the first frame of multimedia data, the playback instance of time of the frame of multimedia data to be the sum of the instance of time of the synchronized clock, the target data transmission delay of time, and the period of time for which each frame of the multimedia data is buffered in the multimedia playing device; and
determine, for each frame of the multimedia data succeeding to the first frame of multimedia data, the playback instance of time of the frame of multimedia data to be the sum of the difference between the play instance of time of the frame of multimedia data and the play instance of time of the first frame of multimedia data, the instance of time of the synchronized clock, the target data transmission delay of time, and the period of time for which each frame of the multimedia data is buffered in the multimedia playing device.

10. The electronic device according to claim 7, wherein the execution of the instructions by the at least one processor further causes the at least one processor to:
for each frame of the multimedia data,
instruct the plurality of multimedia playing devices each to play back the frame of multimedia data upon determining that the playback instance of time of the frame of multimedia data is greater than or equal to the current instance of time of the clock thereof, and the difference between the playback instance of time of the frame of multimedia data and the current instance of time of the clock thereof is less than or equal to a preset threshold;
instruct the plurality of multimedia playing devices each to buffer the frame of multimedia data upon determining that the difference between the playback instance of time of the frame of multimedia data and the current instance of time of the clock thereof is greater than the preset threshold; and
instruct the plurality of multimedia playing devices each to discard the frame of multimedia data upon determining that the playback instance of time of the frame of multimedia data is less than the current instance of time of the clock thereof.

11. The electronic device according to claim 7, wherein the execution of the instructions by the at least one processor further causes the at least one processor to:
synchronize periodically the clock of each multimedia playing device according to the data transmission delay of time of the multimedia playing device.

12. The electronic device according to claim 7, wherein the multimedia playing devices comprise at least one audio playing device and at least one video playing device, and the multimedia data comprise audio data and video data; and the execution of the instructions by the at least one processor further causes the at least one processor to:
transmit the audio data and the playback instance of time of each frame of audio data to the at least one audio playing device, and transmit the video data and the playback instance of time of each frame of video data to the at least one video playing device.

13. A non-transitory computer-readable storage medium storing executable instructions that, when executed by an electronic device with a touch-sensitive display, cause the electronic device to:
synchronize a clock of each multimedia playing device according to a data transmission delay of time of the multimedia playing device;
receive multimedia data comprising a timestamp indicating a play instance of time of each frame of the multimedia data; and
calculate a playback instance of time of each frame of the multimedia data according to an instance of time of the synchronized clock, a target data transmission delay of time, a period of time for which each frame of the multimedia data is buffered in the multimedia playing device and the play instance of time of each frame of the multimedia data indicated by the timestamp, and transmit the multimedia data and the playback instance of time of each frame of the multimedia data to a plurality of multimedia playing devices to instruct the plurality of multimedia playing devices each to play back the multimedia data according to a relationship between the received playback instance of time of each frame of the multimedia data and a current instance of time of a clock thereof, where the target data transmission delay of time is determined among the data transmission delays of time of the plurality of multimedia playing devices under a preset rule.

14. The non-transitory computer-readable storage medium according to claim 13, wherein the executable instructions executed by the electronic device further cause the electronic device to:
transmit for each multimedia playing device a reference instance of time, and the data transmission delay of time of the multimedia playing device to the multimedia playing device to instruct the multimedia playing device to determine the sum of the reference instance of time and the data transmission delay of time as a reference instance of time of the clock in the multimedia playing device.

15. The non-transitory computer-readable storage medium according to claim 13, wherein the executable instructions executed by the electronic device further cause the electronic device to:
determine, for the first frame of multimedia data, the playback instance of time of the frame of multimedia data to be the sum of the instance of time of the synchronized clock, the target data transmission delay of time, and the period of time for which each frame of the multimedia data is buffered in the multimedia playing device; and
determine, for each frame of the multimedia data succeeding to the first frame of multimedia data, the playback instance of time of the frame of multimedia data to be the sum of the difference between the play instance of time of the frame of multimedia data and the play instance of time of the first frame of multimedia data, the instance of time of the synchronized clock, the target data transmission delay of time, and the period of time for which each frame of the multimedia data is buffered in the multimedia playing device.

16. The non-transitory computer-readable storage medium according to claim 13, wherein the executable instructions executed by the electronic device further cause the electronic device to:
for each frame of the multimedia data,
instruct the plurality of multimedia playing devices each to play back the frame of multimedia data upon determining that the playback instance of time of the frame of multimedia data is greater than or equal to the current instance of time of the clock thereof, and the difference between the playback instance of time of the frame of multimedia data and the current instance of time of the clock thereof is less than or equal to a preset threshold;
instruct the plurality of multimedia playing devices each to buffer the frame of multimedia data upon determining that the difference between the playback instance of time of the frame of multimedia data and the current instance of time of the clock thereof is greater than the preset threshold; and
instruct the plurality of multimedia playing devices each to discard the frame of multimedia data upon determining that the playback instance of time of the frame of multimedia data is less than the current instance of time of the clock thereof.

17. The non-transitory computer-readable storage medium according to claim 13, wherein the executable instructions executed by the electronic device further cause the electronic device to:
synchronize periodically the clock of each multimedia playing device according to the data transmission delay of time of the multimedia playing device.

18. The non-transitory computer-readable storage medium according to claim 13, wherein the multimedia playing devices comprise at least one audio playing device and at least one video playing device, and the multimedia data comprise audio data and video data; and the executable instructions executed by the electronic device further cause the electronic device to:
transmit the audio data and the playback instance of time of each frame of audio data to the at least one audio playing device, and transmit the video data and the playback instance of time of each frame of video data to the at least one video playing device.
